(19) United States
(12) Patent Application Publication
(10) Pub. No.: US 2014/0237849 A1
(43) Pub. Date: Aug. 28, 2014

(54) DRYER APPLIANCE WITH FEATURES FOR REDUCING TEMPERATURE GRADIENTS AT OUTLETS OF A DUCT

(71) Applicant: GENERAL ELECTRIC COMPANY, Schenectady, NY (US)

(72) Inventors: Ionelia Silvia Prajescu, Louisville, KY (US); Richard Dustin Henderson, Louisville, KY (US); Daniel John Kelly, Louisville, KY (US)

(73) Assignee: GENERAL ELECTRIC COMPANY, Schenectady, NY (US)

(21) Appl. No.: 13/773,970

(22) Filed: Feb. 22, 2013

(51) Int. Cl. F26B 25/16

(52) U.S. Cl. CPC F26B 25/16
USPC 34/595

(57) ABSTRACT

A dryer appliance is provided. The dryer appliance includes a drum that defines a chamber for receipt of articles for drying and a heating assembly for generating heated air for the chamber of the drum. A duct extends between and fluidly connects the chamber of the drum and the heating assembly. The duct includes outlets for directing heated air from the heating assembly into the chamber of the drum and also includes features for reducing temperature gradients at outlets of the duct.

### FIELD OF THE INVENTION

The present subject matter relates generally to dryer appliances and ducts of the same.

### BACKGROUND OF THE INVENTION

Certain dryer appliances include a cabinet with a drum rotatably mounted therein. A heating assembly, such as an electric resistance heating element or a gas burner, can supply heated air to a chamber of the drum. For example, certain dryer appliances include a duct mounted to a back wall of the drum. The duct can direct heated air from the heating assembly into the chamber of the drum during operation of the dryer appliance. The duct generally includes an inlet that receives heated air from the heating assembly and a plurality of outlets for directing such heated air into the chamber of the drum. Heated air exiting the outlets can assist with drying articles located within the drum's chamber.

Heated air exiting the duct's outlets is preferably below a certain threshold temperature, e.g., to avoid damaging articles that are drying within the chamber of the drum and other overheating problems. To assist with maintaining the heated air's temperature below the threshold temperature, heated air from the heating assembly can be mixed with cooler air within the duct. To permit such mixing, certain ducts include slots or louvers defined in planes that are substantially parallel to the duct's outlets.

However, in order for the dryer appliance to function efficiently, temperature gradients between various outlets of the plurality of outlets are preferably minimized in order to provide a larger overall heat input into the drum's chamber. Certain ducts are too short to permit sufficient mixing between heated air from the heating assembly and cooler air from the slots or louvers. Thus, heated air exiting the duct's outlets can have relatively high temperatures at certain outlets and relatively low temperatures at other outlets. Such temperature gradients can limit efficiency of the dryer appliance due to the threshold temperature restriction on heated air exiting the duct's outlets.

Accordingly, a dryer appliance with features for reducing temperature gradients between outlets of a duct would be useful. In particular, a dryer appliance with features for reducing temperature gradients between outlets of a duct in order to increase heat input into a drum of the dryer appliance would be useful.

### BRIEF DESCRIPTION OF THE INVENTION

The present subject matter provides a dryer appliance. The dryer appliance includes a drum that defines a chamber for receipt of articles for drying and a heating assembly for generating heated air for the chamber of the drum. A duct extends between and fluidly connects the chamber of the drum and the heating assembly. The duct includes outlets for directing heated air from the heating assembly into the chamber of the drum and also includes features for reducing temperature gradients at outlets of the duct. Additional aspects and advantages of the invention will be set forth in part in the following description, or may be apparent from the description, or may be learned through practice of the invention.

In a first exemplary embodiment, a dryer appliance is provided. The dryer appliance defines a lateral direction and a transverse direction that are perpendicular to each other. The dryer appliance includes a cabinet and a drum rotatably mounted within the cabinet. The drum defines a chamber for receipt of articles for drying. The dryer appliance also includes a heating assembly for generating heated air. A duct extends between and fluidly connects the drum and the heating assembly. The duct includes a transversely oriented wall that defines a plurality of outlets for directing heated air within the duct into the chamber of the drum. The duct also includes a laterally oriented wall mounted to the transversely oriented wall. The laterally oriented wall defines at least one opening for directing air into the duct.

In a second exemplary embodiment, a dryer appliance is provided. The dryer appliance defines a vertical direction, a lateral direction, and a transverse direction. The vertical, lateral, and transverse directions are mutually perpendicular. The dryer appliance includes a cabinet and a drum rotatably mounted within the cabinet. The drum defines a chamber for receipt of articles for drying. The dryer appliance also includes a heating assembly for generating heated air. A duct extends between and fluidly connects the drum and the heating assembly. The duct includes a first portion that defines a plurality of outlets for directing heated air within the duct into the chamber of the drum. The plurality of outlets is substantially coplanar within a plane that is perpendicular to the lateral direction. The duct also includes a second portion spaced apart from the first portion along the lateral direction. The second portion is positioned such that the second portion is not parallel to the first portion. The second portion defines at least one opening for directing air into the duct.

In a third exemplary embodiment, a dryer appliance is provided. The dryer appliance defines a lateral direction and a transverse direction. The lateral and transverse directions are perpendicular to each other. The dryer appliance includes a cabinet and a drum rotatably mounted within the cabinet. The drum defines a chamber for receipt of articles for drying. The dryer appliance also includes a heating assembly for generating heated air. A duct extends between and fluidly connects the drum and the heating assembly such that the heating assembly supplies heated air to the chamber of the drum during operation of the dryer appliance. The duct defines a plurality of outlets for directing heated air within the duct into the chamber of the drum. The duct also includes means for reducing temperature gradients between outlets of the plurality of outlets during operating of the dryer appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view a dryer appliance according to an exemplary embodiment of the present subject matter.

FIG. 2 provides another perspective view of the dryer appliance of FIG. 1 with a portion of a cabinet of the dryer appliance removed in order to show certain components of the dryer appliance.

FIG. 3 provides a rear elevation view of a duct of a dryer appliance according to an exemplary embodiment of the present subject matter.

FIG. 4 provides a side elevation view of the duct of FIG. 3.

FIG. 5 provides a front elevation view of the duct of FIG. 3.

FIG. 6 provides another side elevation view of the duct of FIG. 3.

FIGS. 7 and 8 provide plots of temperatures of heated air exiting various outlets of a duct of a dryer appliance.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

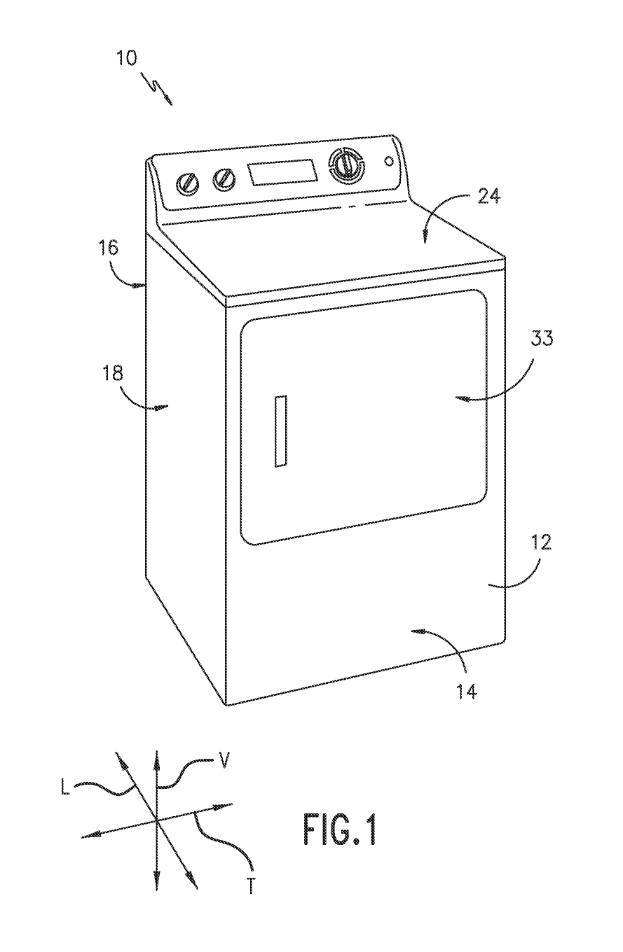

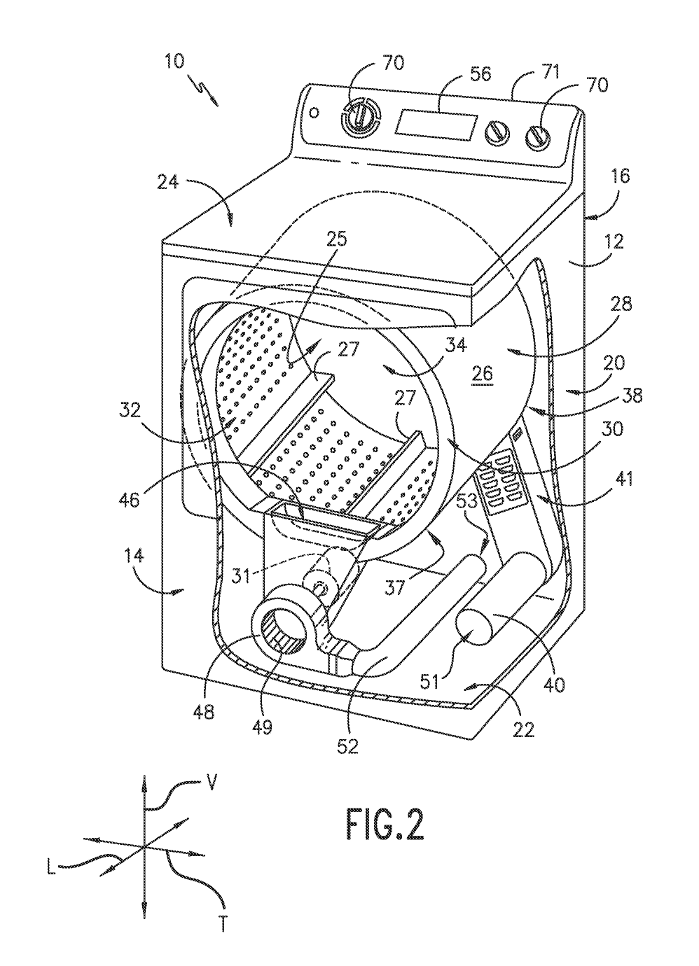

FIG. 1 illustrates a dryer appliance 10 according to an exemplary embodiment of the present subject matter. FIG. 2 provides another perspective view of dryer appliance 10 with a portion of a cabinet or housing 12 of dryer appliance 10 removed in order to show certain components of dryer appliance 10. While described in the context of a specific embodiment of dryer appliance 10, using the teachings disclosed herein it will be understood that dryer appliance 10 is provided by way of example only. Other dryer appliances having different appearances and different features may also be utilized with the present subject matter as well. Dryer appliance 10 defines a vertical direction V, a lateral direction L, and a transverse direction T. The vertical direction V, lateral direction L, and transverse direction T are mutually perpendicular and form and orthogonal direction system.

Cabinet 12 includes a front panel 14, a rear panel 16, a pair of side panels 18 and 20 spaced apart from each other by front and rear panels 14 and 16, a bottom panel 22, and a top cover 24. Within cabinet 12 is a drum or container 26 mounted for rotation about a substantially horizontal axis, e.g., that is parallel or substantially parallel to the lateral direction L. Drum 26 defines a chamber 25 for receipt of articles, e.g., clothing, linen, etc., for drying. Drum 26 extends between a front portion 37 and a back portion 38, e.g., along the lateral direction L.

A motor 31 is configured for rotating drum 26 about the horizontal axis, e.g., via a pulley and a belt (not shown). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of tumbling ribs 27 are provided within chamber 25 of drum 26 to lift articles therein and then allow such articles to tumble back to a bottom of drum 26 as drum 26 rotates. Drum 26 also includes a back or rear wall 34, e.g., at back portion 38 of drum 26. Drum 26 is rotatable on rear wall 34 as will be understood by those skilled in the art. A supply duct 41 is mounted to rear wall 34 and receives heated air that has been heated by a heating assembly or system 40.

Motor 31 is also in mechanical communication with an air handler 48 such that motor 31 rotates a fan 49, e.g., a centrifugal fan, of air handler 48. Air handler 48 is configured for drawing air through chamber 25 of drum 26, e.g., in order to dry articles located therein as discussed in greater detail below. In alternative exemplary embodiments, dryer appliance 10 may include an additional motor (not shown) for rotating fan 49 of air handler 48 independently of drum 26.

Drum 26 is configured to receive heated air that has been heated by a heating assembly 40, e.g., in order to dry damp articles disposed within chamber 25 of drum 26. Heating assembly 40 includes a heating element (not shown), such as a gas burner or an electrical resistance heating element, for heating air. As discussed above, during operation of dryer appliance 10, motor 31 rotates drum 26 and fan 49 of air handler 48 such that air handler 48 draws air through chamber 25 of drum 26 when motor 31 rotates fan 49. In particular, ambient air enters heating assembly 40 via an inlet 51 due to air handler 48 urging such ambient air into inlet 51. Such ambient air is heated within heating assembly 40 and exits heating assembly 40 as heated air. Air handler 48 draws such heated air through supply duct 41 to drum 26. The heated air enters drum 26 through a plurality of outlets (not shown) of supply duct 41 positioned at rear wall 34 of drum 26.

Within chamber 25, the heated air can accumulate moisture, e.g., from damp articles disposed within chamber 25. In turn, air handler 48 draws moisture statured air through a screen filter (not shown) which traps lint particles. Such moisture statured air then enters an exit duct 46 and is passed through air handler 48 to an exhaust duct 52. From exhaust duct 52, such moisture statured air passes out of dryer appliance 10 through a vent 53 defined by cabinet 12. After the clothing articles have been dried, they are removed from the drum 26 via opening 32. A door 33 provides for closing or accessing drum 26 through opening 32.

A cycle selector knob 70 is mounted on a cabinet backsplash 71 and is in communication with a processing device or controller 56. Signals generated in controller 56 operate motor 31 and heating assembly 40 in response to the position of selector knobs 70. Alternatively, a touch screen type interface may be provided. As used herein, “processing device” or “controller” may refer to one or more microprocessors or semiconductor devices and is not restricted necessarily to a single element. The processing device can be programmed to operate drying machine 10. The processing device may include, or be associated with, one or more memory elements such as e.g., electrically erasable, programmable read only memory (EEPROM).

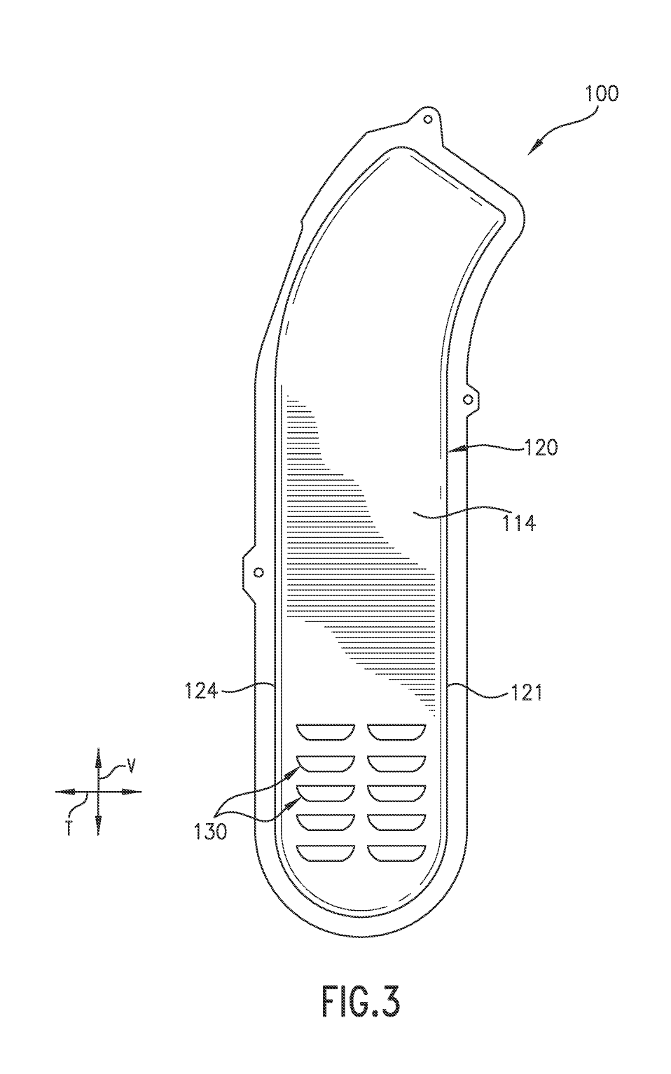

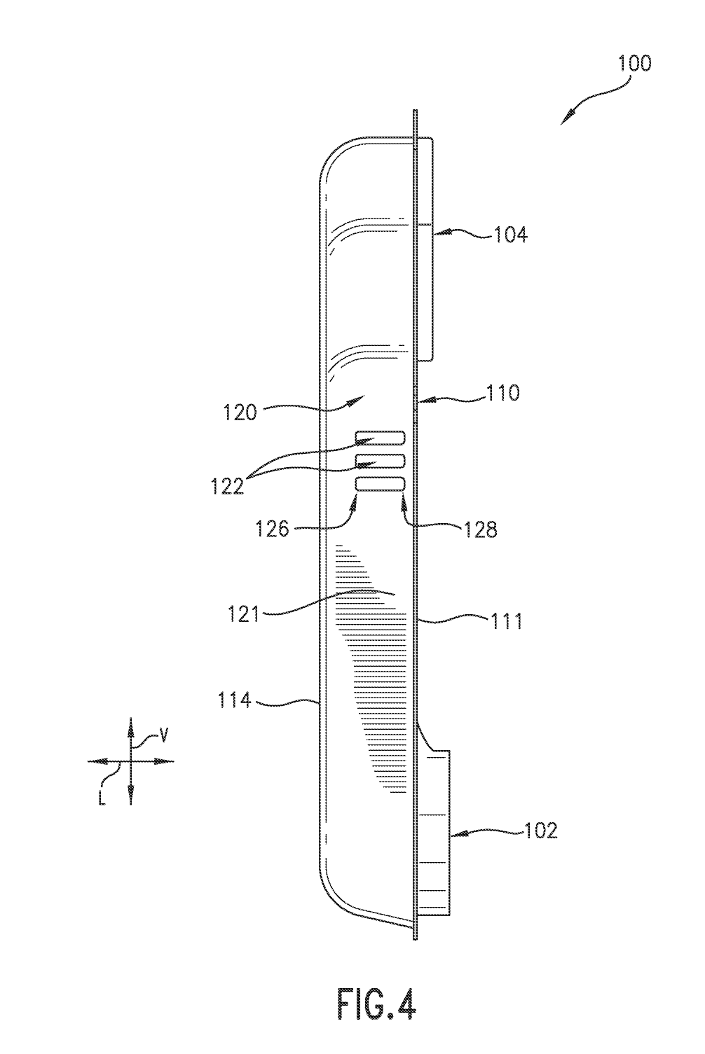

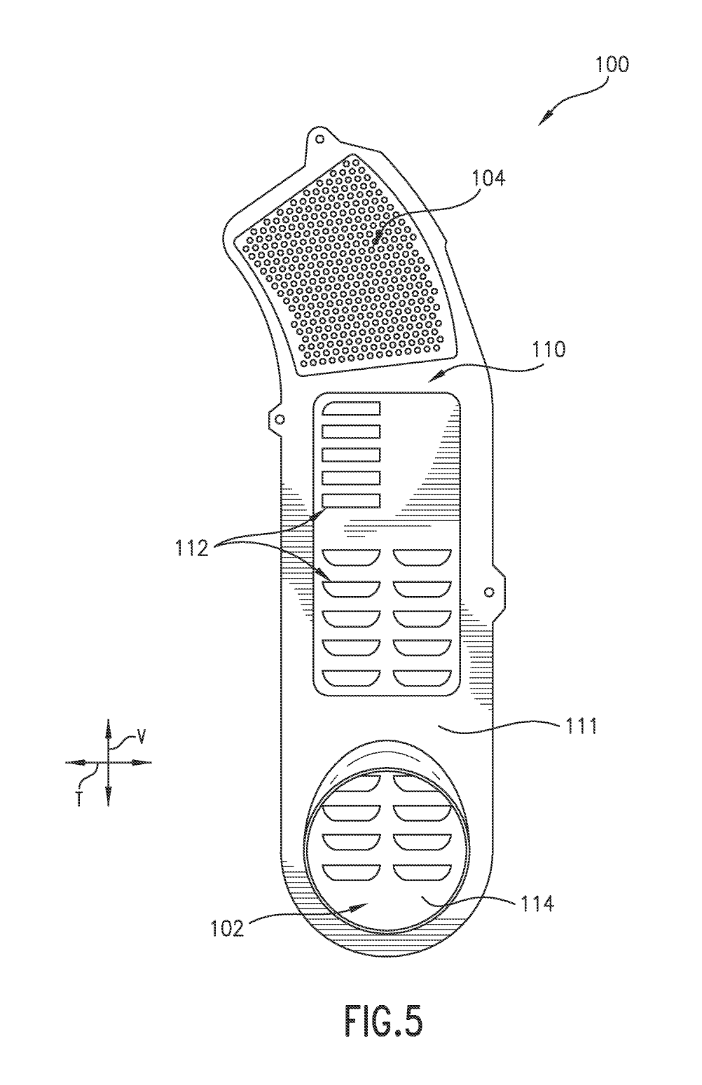

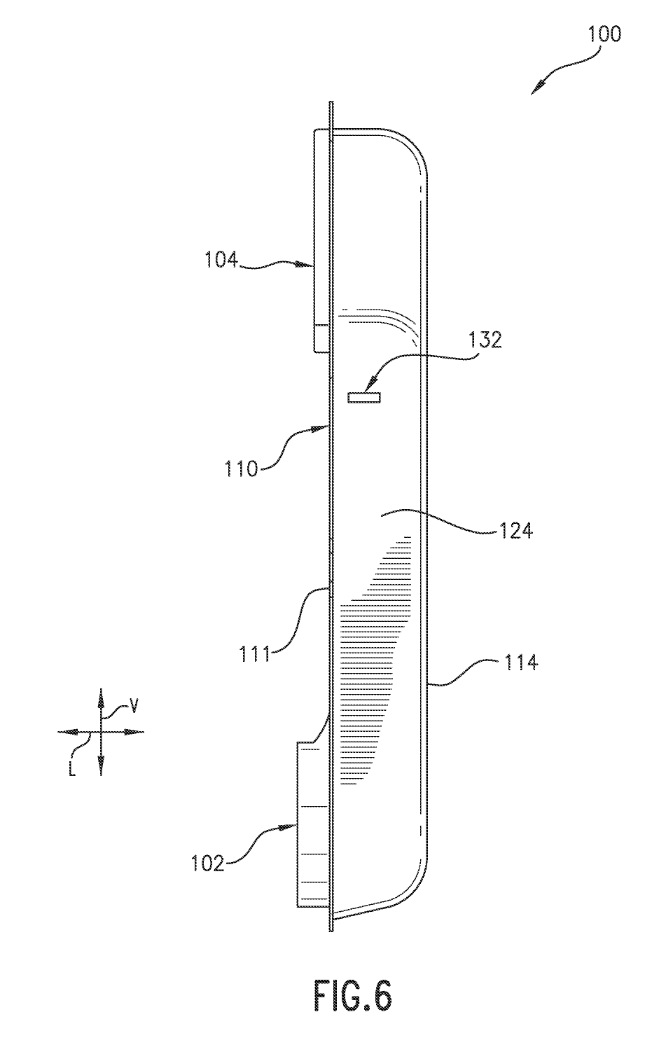

FIG. 3 provides a rear elevation view of a duct 100 of a dryer appliance according to an exemplary embodiment of the present subject matter. FIG. 4 provides a side elevation view of duct 100. FIG. 5 provides a front elevation view of duct 100. FIG. 6 provides another side elevation view of duct 100. Duct 100 can be used in any suitable dryer appliance. As an example, duct 100 may be used as supply duct 41 of dryer appliance 10 (FIG. 2). Thus, duct 100 can extend between and fluidly connect heating assembly 40 and chamber 25 of drum 26, e.g., such that duct 100 supplied heated air from heating assembly 40 to chamber 25 of drum 26 as described above.

Duct 100 extends between an inlet 102 and a plurality of outlets 104, e.g., along the vertical direction V. Inlet 102 is configured for receipt of heated air, e.g., from heating assembly 40. Plurality of outlets 104 is configured for directing such heated air out of duct 100, e.g., into chamber 25 of drum 26. As discussed in greater detail below, duct 100 also includes features for directing relatively cool air into duct 100 in order to regulate a temperature of heated air exiting plurality of outlets 104 by mixing such relatively cool air with heated air from heating assembly 40.

Duct 100 includes a first portion 110, such as a transversely oriented wall 111. Duct 100 also includes a second portion 120, such as a laterally oriented wall 121. Second portion 120 is spaced apart from first portion 110, e.g., along the lateral direction L. In particular, second portion 120 is mounted to and extends away from first portion 110 and is positioned such that second portion 120 is not parallel to first portion 110. Thus, laterally oriented wall 121 is mounted to transversely oriented wall 111 and is positioned such that laterally oriented wall 121 is not parallel to transversely oriented wall 111. In particular, laterally oriented wall 121 can be positioned such that laterally oriented wall 121 is substantially perpendicular to transversely oriented wall 111.

First portion 110 defines plurality of outlets 104. In particular, first portion 110 can define plurality of outlets 104 such that the outlets of plurality of outlets 104 are substantially coplanar within a plane that is perpendicular to the lateral direction L. As discussed above, duct 100 includes features for directing relatively cool air into duct 100. In particular, second portion 120 defines at least one opening 122 for directing, e.g., relatively cool, air into duct 100. Each opening of the at least one opening 122 of second portion 120 can extend between a first side portion 126 and a second side portion 128. First and second side portions 126 and 128 of the at least one opening 122 of second portion 120 are spaced apart from each other, e.g., along the lateral direction L. The at least one opening 122 of second portion 120 can be any suitable opening. For example, the at least one opening 122 of second portion 120 can include a laterally oriented slot, a laterally oriented louver, or both.

During operating of dryer appliance 10, fan 49 of air handler 48 can draw heated air from heating assembly 40 into chamber 25 of drum 26 through duct 100. In particular, such heated air can enter chamber 25 of drum 26 at plurality of outlets 104 of duct 100. To limit or regulate a temperature of such heated air, relatively cool air, e.g., from within cabinet 12, can enter duct 100 through the at least one opening 122 of second portion 120 and mix with heated air from heating assembly 40 within duct 100. As discussed in greater detail below, providing the at least one opening 122 of second portion 120 can also assist with uniformly or evenly mixing relatively cool air from the at least one opening 122 of second portion 120 and heated air from heating assembly 40 within duct 100.

To further assist with limiting or regulating the temperature of heated air entering chamber 25 of drum 25 at plurality of outlets 104, first portion 110 defines at least one opening 112 for directing, e.g., relatively cool, air into duct 100. The at least one opening 112 of first portion 110 can be any suitable opening. For example, the at least one opening 112 of first portion 110 can include a transversely oriented louver, a transversely oriented slot, or both. The at least one opening 112 of first portion 110 can be positioned such that the at least one opening 112 of first portion 110 is substantially coplanar with outlets 104 of first portion 110, e.g., within a plane that is perpendicular to the lateral direction L. During operating of dryer appliance 10, relatively cool air, e.g., from within cabinet 12, can enter duct 100 through the at least one opening 112 of first portion 110 and mix with heated air from heating assembly 40 within duct 100, e.g., in a similar manner as described above for the at least one opening 122 of second portion 120.

Duct 100 also includes a second or additional transversely oriented wall 114 spaced apart from (e.g., first) transversely oriented wall 111, e.g., along the lateral direction L. First and second transversely oriented walls 111 and 114 can be substantially parallel to each other. Duct 100 further includes a second or additional laterally oriented wall 124 spaced apart from (e.g., first) laterally oriented wall 121, e.g., along the transverse direction T. First and second laterally oriented walls 121 and 124 can be substantially parallel to each other. First and second laterally oriented walls 121 and 124 extend between and connect first and second transversely oriented walls 111 and 114, e.g., along the lateral direction L. Thus, duct 100 can have a rectangular profile or shape, e.g., in a plane that is perpendicular to the vertical direction V.

Additional transversely oriented wall 114 can define at least one opening 130 for directing air into duct 100, e.g., in a similar manner to the at least one opening 112 of first portion 110. Similarly, additional laterally oriented wall 124 can define at least one opening 132 for directing air into duct 100, e.g., in a similar manner to the at least one opening 122 of second portion 120. The at least one opening 130 of additional transversely oriented wall 114 can be any suitable opening. For example, the at least one opening 130 of additional transversely oriented wall 114 can include a transversely oriented louver, a transversely oriented slot, or both. Similarly, the at least one opening 132 of additional laterally oriented wall 124 can be any suitable opening. For example, the at least one opening 132 of additional laterally oriented wall 124 can include a laterally oriented louver, a laterally oriented slot, or both.

In the exemplary embodiment shown in FIGS. 3-6, first portion 110 is conducted with or from a stamped metal sheet, and second portion 120 is constructed with or from another stamped metal sheet. Thus, first transversely oriented wall 111 can constructed with a stamped metal sheet, and second transversely oriented wall 114 and first and second laterally oriented walls 121 and 124 can be constructed with another stamped metal sheet. In alternative exemplary embodiments, duct 100 can be constructed in any other suitable manner. For example, first and second transversely oriented walls 111 and 114 and first and second laterally oriented walls 121 and 124 can be constructed with a single metal sheet. Alternatively, second transversely oriented wall 114 can constructed with a stamped metal sheet, and first transversely oriented wall 111 and first and second laterally oriented walls 121 and 124 can be constructed with another stamped metal sheet.

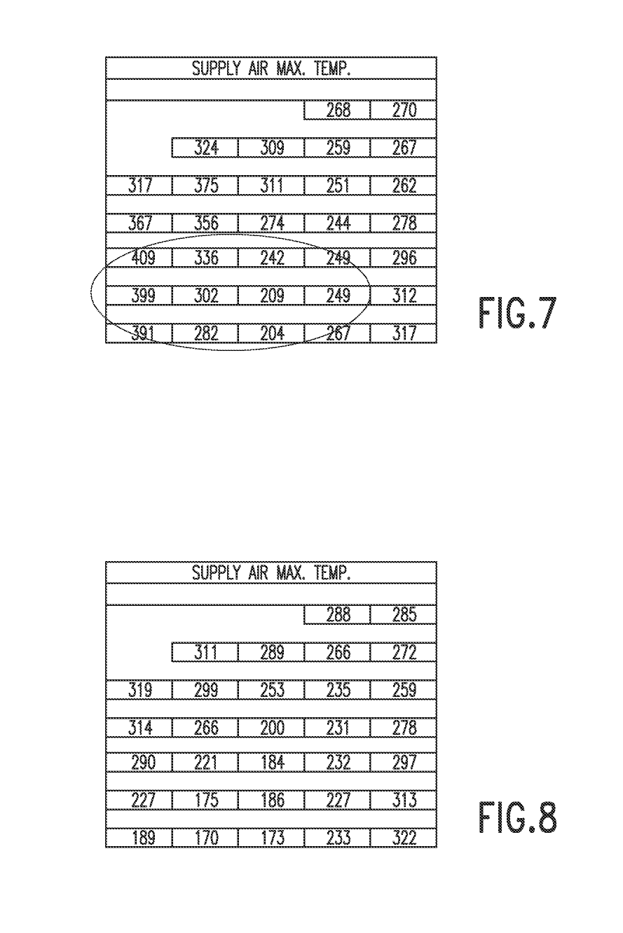

FIGS. 7 and 8 provide plots of temperatures of heated air exiting various outlets of the plurality of outlets 104 of duct 100. As will be understood by those skilled in the art, temperature gradients between the various outlets of the plurality of outlets 104 can decrease an efficiency of dryer appliance 10, e.g., by decreasing the total heat input into chamber 25 of drum 26. By providing the at least one opening 122 of second portion 120, temperature gradients between the various outlets of the plurality of outlets 104 can be reduced. For example, the at least one opening 122 of second portion 120 can assist with mixing relatively cool air, e.g., from cabinet 12, and heated air from heating assembly 40 within duct 100.

FIG. 7 illustrates temperatures of heated air exiting various outlets of the plurality of outlets 104 for duct 100 with only openings 112 and 130. As may be seen in FIG. 7, the maximum temperature gradient between outlets 104 is two hundred and five degrees Fahrenheit in such a configuration. FIG. 8 illustrates temperatures of heated air exiting various outlets of the plurality of outlets 104 for duct 100 with all of openings 112, 122, 130, and 132. As may be seen in FIG. 8, the maximum temperature gradient between outlets 104 is one hundred and fifty two degrees Fahrenheit in such a configuration. Thus, as may be seen in FIGS. 7 and 8, providing the at least one opening 122 of second portion 120 can assist with reducing temperature gradients at outlets of the plurality of outlets 104, e.g., relative to duct 100 without the at least one opening 122 of second portion 120.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dryer appliance, the dryer appliance defining a lateral direction and a transverse direction that are perpendicular to each other, the dryer appliance comprising:
a cabinet;
a drum rotatably mounted within said cabinet, said drum defining a chamber for receipt of articles for drying;
a heating assembly for generating heated air; and
a duct extending between and fluidly connecting said drum and said heating assembly, said duct comprising
a transversely oriented wall that defines a plurality of outlets for directing heated air within said duct into the chamber of said drum; and
a laterally oriented wall mounted to said transversely oriented wall, said laterally oriented wall defining at least one opening for directing air into said duct.

2. The dryer appliance of claim 1, wherein said drum extends between a front portion and a back portion, said drum defining an opening for accessing the chamber of said drum at the front portion of said drum, said drum having a back wall positioned at the back portion of said drum, said duct mounted to said drum at the back wall of said drum.

3. The dryer appliance of claim 1, wherein the at least one opening of said laterally oriented wall comprises at least one laterally oriented slot.

4. The dryer appliance of claim 1, wherein said transversely oriented wall defines at least one opening for directing air into said duct.

5. The dryer appliance of claim 4, wherein the at least one opening of said transversely oriented wall comprises at least one transversely oriented louver. The dryer appliance of claim 1, wherein said transversely oriented wall is a first transversely oriented wall and said laterally oriented wall is a first laterally oriented wall, said duct further comprising a second transversely oriented wall spaced apart from said first transversely oriented wall along the lateral direction and a second laterally oriented wall spaced apart from said first laterally oriented wall along the transverse direction, said first and second laterally oriented walls extending between said first and second transversely oriented walls along the lateral direction.

6. The dryer appliance of claim 0, wherein said second laterally oriented wall defines at least one opening for directing air into said duct.

7. The dryer appliance of claim 0, wherein each of said first and second transversely oriented walls defines at least one opening for directing air into said duct.

8. The dryer appliance of claim 7, wherein the at least opening of said first and second transversely oriented walls comprises at least one transversely oriented slot.

9. The dryer appliance of claim 0, wherein said first transversely oriented wall is constructed with a stamped metal sheet, and said second transversely oriented wall and said first and second laterally oriented walls are constructed with another stamped metal sheet.

10. A dryer appliance, the dryer appliance defining a vertical direction, a lateral direction, and a transverse direction, the vertical, lateral, and transverse directions being mutually perpendicular, the dryer appliance comprising:
a cabinet;
a drum rotatably mounted within said cabinet, said drum defining a chamber for receipt of articles for drying;
a heating assembly for generating heated air; and
a duct extending between and fluidly connecting said drum and said heating assembly, said duct comprising
a first portion that defines a plurality of outlets for directing heated air within said duct into the chamber of said drum, the plurality of outlets being substantially coplanar within a plane that is perpendicular to the lateral direction; and
a second portion spaced apart from said first portion along the lateral direction, said second portion positioned such that said second portion is not parallel to said first portion, said second portion defining at least one opening for directing air into said duct.

11. The dryer appliance of claim 1, wherein the at least one opening extends between a first side portion and a second side portion, the first and second side portions of the at least one opening spaced apart from each other along the lateral direction.

12. The dryer appliance of claim 1, wherein the at least one opening comprises a laterally oriented slot, a laterally oriented louver, or both.

13. The dryer appliance of claim 1, wherein said drum extends between a front portion and a back portion, said drum defining an opening for accessing the chamber of said drum at the front portion of said drum, said drum having a back wall positioned at the back portion of said drum, said duct mounted to said drum at the back wall of said drum.

14. The dryer appliance of claim 1, wherein said first and second portions are substantially perpendicular to each other.

15. The dryer appliance of claim 1, wherein said first portion defines at least one opening for directing air into said duct.

16. The dryer appliance of claim 1, wherein the at least one opening of said first portion comprises at least one transversely oriented louver.

17. The dryer appliance of claim 1, wherein said first portion comprises a stamped metal sheet and said second portion comprises an additional stamped metal sheet.

18. A dryer appliance, the dryer appliance defining a lateral direction and a transverse direction, the lateral and transverse directions being perpendicular to each other, the dryer appliance comprising:
a cabinet;
a drum rotatably mounted within said cabinet, said drum defining a chamber for receipt of articles for drying;
a heating assembly for generating heated air; and
a duct extending between and fluidly connecting said drum and said heating assembly such that said heating assembly supplies heated air to the chamber of said drum during operation of the dryer appliance, said duct defining a plurality of outlets for directing heated air within said duct into the chamber of said drum, said duct comprising means for reducing temperature gradients between outlets of the plurality of outlets during operating of the dryer appliance.
